(19) United States
(12) Patent Application Publication
(10) Pub. No.: US 2012/0250165 A1
(43) Pub. Date: Oct. 4, 2012

(54) WIDE-ANGLE LENS AND SYSTEM ENCLOSING WIDE-ANGLE LENS

(75) Inventor: Satoshi Do, Saitama (JP)

(73) Assignee: Satoshi Do, 351-0031 Saitama (JP)

(21) Appl. No.: 13/512,369

(22) PCT Filed: Dec. 13, 2010
(86) PCT No.: PCT/JP10/72370

§ 371 Date: May 29, 2012

(30) Foreign Application Priority Data
Dec. 14, 2009 (JP) 2009-282374
Dec. 13, 2010 (JP) 2010-276603

(51) Int. Cl. G02B 13/18

(52) U.S. Cl. 359/715

(57) ABSTRACT

Conventional wide angle lenses each do not have such features that an optical length is short, a back focus is long to the extent possible, a good image is obtained, and sufficient brightness is provided. In other words, it is difficult to perform sufficient correction of chromatic aberration and achieve sufficient downsizing. Provided is a wide angle lens provided with a first lens L1, a second lens L2, a third lens L3, an aperture stop S, and a fourth lens L4. The wide angle lens is configured by arranging the first lens L1, the second lens L2, the third lens L3, the aperture stop S, and the fourth lens L4 in this order from the side of an object toward the side of an image. The first lens L1 is a meniscus lens having a negative refractive power, the convex surface of which faces the side of the object. The second lens L2 is a meniscus lens having a positive refractive power, the convex surface of which faces the side of the image. The third lens L3 and the fourth lens L4 are lenses having the positive refractive power.

### TECHNICAL FIELD

The present invention relates to an imaging lens, and more particularly to a wide-angle lens which is suitable for an imaging device using such a solid-state image sensor as an on-vehicle camera (e.g. camera for rear monitoring, camera for driving recorder), monitoring camera, intercom camera, crime prevention camera, camera embedded in portable equipment, conference camera, TV camera, endoscope and miniature medical capsule. The present invention also relates to a semiconductor device enclosing a solid-state image sensor which is a semiconductor, and devices and systems related to this semiconductor device.

### BACKGROUND ART

Many wide-angle lenses suitable for the above mentioned applications have been proposed, and a wide-angle lens configured as a lens system in which a plurality of single lenses are combined has been disclosed in documents. In order to create a compact imaging device, a wide-angle lens to be installed is also demanded to be compact, hence less number of single lenses to be combined the better. However the quality of an image to be formed decreases as a number of lenses to be combined decreases, therefore a required number of lenses to be combined is determined considering the required image quality.

Here a wide-angle lens refers to an imaging lens which covers an imaging range provided by a wider angle of view compared with an imaging lens referred to as a “standard lens” or a “telephoto lens”. Generally definitions of a wide-angle lens, standard lens and telephoto lens, based on angle of view and other characteristics, are not strict, and distinctions thereof are not absolute. Therefore an imaging lens referred to as a “wide-angle lens” here merely refers to an imaging lens that is fabricated with the intention of use for an object of which imageable range is preferably as wide as possible.

In a wide-angle lens installed in the above mentioned imaging devices, the optical length must be short. In other words, when the wide-angle lens is constructed, the ratio of the optical length to the focal length of the wide-angle lens must be small. The optical length here refers to a length defined as a distance from an entrance plane of the wide-angle lens (on the object side) to the image formation plane (light receiving plane of the solid-state image sensor). Hereafter a wide-angle lens of which ratio of the optical length to the focal length is small may be called a “compact wide-angle lens”, and implementing a compact wide-angle lens may be called “making a wide-angle lens compact”. In the case of a portable telephone, for example, the optical length must be at least shorter than the thickness of the portable telephone main body.

For a wide-angle lens, it is naturally demanded that distortion of an image is not visually recognized, and various aberrations have been corrected sufficiently into levels that are demanded for implementing the integration density of the minimum unit elements to detect light (also called “pixels”), which are arrayed in a matrix on the light receiving plane of a CCD (Charge Coupled Device) image sensor or the like. In other words, various aberrations must be corrected ideally for a wide-angle lens. Hereafter an image of which various aberrations have been corrected ideally may be called an “ideal image”.

As an example of a wide-angle lens suitable for the above mentioned imaging devices using a small solid-state image sensor, the following first to seventh wide-angle lenses have been disclosed (see Patent Documents 1 to 7).

In terms of making the wide-angle lens light and compact, it is appropriate that a number of lenses to be combined is four or less. The first to seventh wide-angle lenses described hereinbelow are wide-angle lenses constituted by four single lenses which are combined.

The first and second wide-angle lenses are wide-angle lenses that can prevent the shading phenomena.

When the incident angle of a ray that enters the light receiving plane of the image sensor deviates from the vertical angle, the light receiving sensitivity drops, and the shading phenomena occurs, that is the image formed on the image sensor becomes darker as the area becomes closer to the edge of the image. To prevent the shading phenomena, the rays that enter the light receiving plane of the image sensor should enter at approximately a vertical angle all through the center portion to the edge portion of the image. One method that allows rays to enter the entire surface of the light receiving plane of the image sensor at an approximately vertical incident angle is to make the rear focal length of the wide-angle lens as long as possible. In other words, the first and second wide-angle lenses are wide-angle lenses which can prevent the shading phenomena based on this method.

The first wide-angle lens comprises, in order from the object, a first group lens having negative power and a second group lens having positive power, and the second group lens has a front group lens disposed on the object side and a rear group lens disposed on the opposite side. An Abbe number of a material of the front group lens, that is the second lens disposed in the second place from the object, is set to a value less than 45 (see Patent Document 1)

Here a plurality of single lenses constituting the wide-angle lens is denoted, in order from the object, as the first lens, the second lens, the third lens and the fourth lens.

The second wide-angle lens comprises, in order from the object, a first group lens having negative power and a second group lens having positive power. The second group lens has a front lens disposed on the object side and a rear lens disposed on the opposite side. The first group lens has a first lens and a second lens, and the front lens and the rear lens of the second group lens are constituted by one aspherical lens respectively. An Abbe number of a material of the front lens, that is the third lens, is set to a value less than 45 (see Patent Document 2).

The third wide-angle lens is a wide-angle lens which can prevent the shading phenomena, and is constituted by two groups, totaling four lenses, where a first lens group I and a second lens group II are disposed, in order from the object to the image formation plane of the light receiving element. The first lens group I has a first lens which is a meniscus lens having negative power of which convex surface facing the object, and a second lens having a negative power of which surface having a low curvature faces the image forming plane (see Patent Document 3). In other words, among the four single lenses constituting the third wide-angle lens, the second lens disposed in second place from the object is a single lens having negative power of which surface having a low curvature faces the image forming plane.

The fourth wide-angle lens is a wide-angle lens constituted by four single lenses, and has an ideal optical performance and a wide full angle of view as an optical system for a solid-state image sensor, and comprises, in order from the object, a first lens which is a negative meniscus lens having a convex surface facing the object, a second lens which is a biconcave lens, a third lens which is a biconvex lens, and a fourth lens which is a positive meniscus lens having the convex surface facing the image (see Patent Document 4). The second lens, which is a biconcave lens, is a single lens having negative refractive power.

The fifth wide-angle lens is a wide-angle lens for imaging in a near infrared region, having a combination of lenses in which every other lens is an aspherical lens that has either positive or negative refractive power which is different from the previous one, and the second lens having negative refractive power and the fourth lens having positive refractive power are double-sided aspherical lenses, whereby aberrations can be efficiently corrected using a small number of aspherical lenses (see Patent Document 5).

The sixth wide-angle lens is a wide-angle lens which has long back focus and is compact, and comprises, in order from the object, a first lens which is a negative meniscus lens having a convex surface facing the object, a second lens having negative refractive power, a third lens having positive refractive power of which convex surface faces the object, an aperture stop, and a fourth lens which is a biconvex lens having positive refractive power (see Patent Document 6).

The seventh wide-angle lens is a wide-angle lens which can prevent the shading phenomena, and comprises, in order from the object, a first group lens having negative power and a second group lens having positive power, and the second group lens has a front group lens disposed on the object side and a rear group lens disposed on the opposite side, with an aperture stop therebetween. The first group lens is constituted by a first lens and a second lens. The second lens is a single lens disposed in the second place from the object, and this second lens has negative refractive power. Furthermore, an Abbe number of the material of the front group lens constituting the second group lens, that is a single lens disposed in the third place from the object, is set to a value less than 45 (see Patent Document 7).
Patent Document 1: Japanese Patent Application Laid-Open No. 2002-244031
Patent Document 2: Japanese Patent Application Laid-Open No. 2007-264676
Patent Document 3: Japanese Patent Application Laid-Open No. 2005-227426
Patent Document 4: Japanese Patent Application Laid-Open No. 2006-292988
Patent Document 5: Japanese Patent Application Laid-Open No. 2007-094032
Patent Document 6: Japanese Patent Application Laid-Open No. 2008-242040
Patent Document 7: Japanese Patent Application Laid-Open No. 2009-080507

### DISCLOSURE OF THE INVENTION

As described above, the Abbe number of the material of the second lens of the first wide-angle lens is set to a value less than 45, and the Abbe number of the material of the third lens of the second wide-angle lens is set to a value less than 45. Therefore correction of chromatic aberration is insufficient for both the first and second wide-angle lenses.

In the case of the third to sixth wide-angle lenses, a single lens having negative power is used for the second lens, which is disposed in the second place from the object, among the four single lenses. This makes it difficult to decrease the effective aperture of the first lens disposed in the first place from the object. Since it cannot be avoided making the effective aperture of the first lens large, the third to sixth wide-angle lenses cannot be sufficiently compact.

In the case of the seventh wide-angle lens, a lens having negative refractive power is used for the second lens disposed in the second place from the object, among the four single lenses, which makes it difficult to decrease the effective aperture of the first lens disposed in the first place from the object. Therefore just like the case of the third to sixth wide-angle lenses, it is difficult to make the seventh wide-angle lens sufficiently compact. Furthermore the Abbe number of the material of the single lens disposed in the third place from the object is set to a value less than 45, hence correction of chromatic aberration is insufficient for the seventh wide-angle lens, just like the case of the first and second wide-angle lenses.

In other words, the wide-angle lenses disclosed in conventional documents have no characteristics indicating that the optical length is short, the back focus is as long as possible, and a good image is acquired.

Here “optical length is short” means that the ratio of the optical length to the combined focal length is small. “Back focus is as long as possible” means that the ratio of the back focus to the focal length is as long as possible.

A wide-angle lens of this invention comprises a first lens L1, a second lens L2, a third lens L3, an aperture stop S, and a fourth lens L4, which are disposed, from an object toward an image, in order of the first lens L1, the second lens L2, the third lens L3, the aperture stop S and the fourth lens L4. The first lens L1 is a meniscus lens having negative refractive power, of which convex surface faces the object. The second lens L2 is a meniscus lens having positive refractive power, of which convex surface faces the image. The third lens L3 and the fourth lens L4 are lenses having positive refractive power. At least both sides of the second lens L2 and those of the third lens L3 are aspherical.

A system enclosing the wide-angle lens of this invention comprises a wide-angle lens and a first semiconductor device which converts optical image information received via the wide-angle lens into a first electric signal via a semiconductor chip disposed on the image side of the wide-angle lens, wherein said wide-angle lens includes a first lens L1, a second lens L2, a third lens L3, an aperture stop S and a fourth lens L4, which are disposed from an object toward the image, in order of the first lens L1, the second lens L2, the third lens L3, the aperture stop S and the fourth lens L4, wherein said first lens L1 is a meniscus lens having negative refractive power, of which convex surface faces the object, the second lens L2 is a meniscus lens having positive refractive power, of which convex surface faces the image, the third lens L3 and the fourth lens L4 are lenses having positive refractive power, and at least both surfaces of the second lens L2 and those of the third lens L3 are aspherical.

According to this invention, a wide-angle lens of which optical length is short, back focus is as long as possible, and image to be obtained is ideal, can be implemented. For example, a compact wide-angle lens which has bright characteristics (e.g. F number, which is one of the indexes to indicate brightness of the lens, is about 2.8), and is constituted by a small number of lenses (a four-lens configuration), can be implemented. Hence a compact and high performance system, such as a high performance camera, can be implemented by enclosing the wide-angle lens of this invention.

### BRIEF DESCRIPTION OF THE DRAWINGS

FIG. 1 is a cross-sectional view depicting wide-angle lens according to an embodiment of the present invention;

FIG. 2 is a cross-sectional view of a wide-angle lens according to Example 1-1;

FIG. 3 is a graph of the chromatic/spherical aberration of the wide-angle lens of Example 1-1;

FIG. 4 is a graph of the astigmatism of the wide-angle lens of Example 1-1;

FIG. 5 is a graph of the distortion of the wide-angle lens of Example 1-1;

FIG. 6 is a cross-sectional view of a wide-angle lens according to Example 1-2;

FIG. 7 is a graph of the chromatic/spherical aberration of the wide-angle lens of Example 1-2;

FIG. 8 is a graph of the astigmatism of the wide-angle lens of Example 1-2;

FIG. 9 is a graph of the distortion of a wide-angle lens of Example 1-2;

FIG. 10 is a cross-sectional view of a wide-angle lens according to Example 1-3;

FIG. 11 is a graph of the chromatic/spherical aberration of the wide-angle lens of Example 1-3;

FIG. 12 is a graph of the astigmatism of the wide-angle lens of Example 1-3;

FIG. 13 is a graph of the distortion of a wide-angle lens of Example 1-3;

FIG. 14 is a cross-sectional view of the wide-angle lens according to Example 1-4;

FIG. 15 is a graph of the chromatic/spherical aberration of the wide-angle lens of Example 1-4;

FIG. 16 is a graph of the astigmatism of the wide-angle lens of Example 1-4;

FIG. 17 is a graph of the distortion of the wide-angle lens of Example 1-4;

FIG. 18 is a schematic cross-sectional view depicting a general configuration of a system of Example 2-1 enclosing the wide-angle lens of the embodiment of the present invention;

FIG. 19 is a block diagram depicting a general configuration of a system of Example 2-2 enclosing the wide-angle lens of the embodiment of the present invention; and

FIG. 20 is a block diagram depicting a general configuration of a system of Example 2-3 enclosing the wide-angle lens of the embodiment of the present invention.

### BEST MODE FOR CARRYING OUT THE INVENTION

A typical example of the technical concept solving the problems according to the present invention will be described. The content claimed in this application however is not limited to this technical concept, but includes the content stated in the Claims.

It was discovered that if the second lens disposed in the second place from the object, out of the total four single lenses constituting the wide-angle lens, is a lens having positive power, [the size of] the effective aperture of the first lens disposed in the first place from the object can be decreased, and the wide-angle lens can effectively be made compact. It was also discovered that if the relationship between the Abbe number of the material of the second lens disposed in the second place from the object and the Abbe number of the material of the third lens disposed in the third place from the object is appropriately set, chromatic aberration can be sufficiently corrected.

According to the subject matter based on this concept, wide-angle lenses having the following configurations are provided.

A wide-angle lens according to this embodiment comprises a first lens L1, a second lens L2, a third lens L3, an aperture stop S, and a fourth lens L4, which are disposed, from an object, in order of the first lens L1, the second lens L2, the third lens L3, the aperture stops and the fourth lens L4. The first lens L1 is a meniscus lens having negative refractive power, of which convex surface faces the object. The second lens L2 is a meniscus lens having positive refractive power, of which convex surface faces the image. The third lens L3 and the fourth lens L4 are lenses having positive refractive power. At least both sides of the second lens L2 and those of the third lens L3 are aspherical.

For example, it is preferable to satisfy the following condition in order to implement a compact wide-angle lens. In other words, the following conditional expression (1) is satisfied:

0.15≦f/D≦0.20 (1)

where f denotes a combined focal length provided by the four lenses, that is the first lens L1, the second lens L2, the third lens L3 and the fourth lens L4, and D denotes a distance from the entrance plane on the object side to the image formation plane.

It is also preferable to satisfy the following condition in order to implement a wide-angle lens with which an ideal image can be acquired. In other words, the following conditional expressions (2) and (3) are satisfied:

23≦ν_{d2}≦40 (2)

85≧ν_{d3}≧50 (3)

where ν_{d2} denotes an Abbe number of the material of the second lens, and ν_{d3} denotes an Abbe number of the material of the third lens.

If it is necessary to minimize the damage to the single lenses constituting the wide-angle lens due to heat received by the solid-state image sensor included in the imaging device enclosing the wide angle lens, it is preferable that the fourth lens L4 is a lens formed of optical glass as a material.

If the wide-angle lens is expected to be used under a harsh environment, such as in a serious rain storm or sand storm, it is preferable that the first lens L1 is a lens formed of optical glass as a material.

However in many cases, damage resistance of the first lens L1 and heat resistance of the fourth lens L4 in the application of wide-angle lenses are not strongly demanded to require optical glass. In such a case, all of the first lens L1 to the fourth lens L4 may be formed of optical resin as a material, in order to simplify the manufacturing steps and to decrease manufacturing cost.

If the first lens L1 to the fourth lens L4 are formed of optical resin as a material, it is preferable that the first lens L1, the third lens L3 and the fourth lens L4 are formed of cycloolefin optical resin, and the second lens L2 is formed of polycarbonate optical resin.

Due to the technical concept described above, a wide-angle lens having the following characteristics can be implemented: optical length is short; back focus is as long as possible; an ideal image is acquired; and lenses have sufficient brightness. For example, sufficient brightness characteristics (e.g. F number is about 2.8) can be implemented even if the wide-angle lens is constituted by a small number of lenses (four-lens configuration), hence a compact and high performance camera can be implemented.

Through simulation and prototyping, it was confirmed that the size of the effective aperture of the first lens L1 can be decreased, and the optical length can be shortened by designing the second lens L2 to be a meniscus lens having positive refractive power, of which convex surface faces the image.

Also through simulation and prototyping, it was confirmed that satisfying the conditional expression (1) as the conditions for the optical length is preferable in order to implement a compact wide-angle lens of which optical length is short and back focus is as long as possible.

If the lower limit of the expression (1) is not reached, the optical length must be increased to ensure sufficient back focus, which is defined as a distance from the image side surface to the imaging plane of the fourth lens L4, therefore it becomes difficult to make the wide-angle lens compact. If the upper limit is exceeded, a wide angle of view cannot be secured, and functions as a wide-angle lens are diminished. Having a wide angle of view is critical for a lens installed on a monitoring camera or on an on-vehicle camera, and this demand cannot be satisfied if the upper limit is exceeded. If the upper limit is exceeded, it also becomes difficult to sufficiently secure a back focus, which is defined as a distance from the image side surface to the imaging plane of the fourth lens L4.

In other words, if the value of f/D does not exceed the upper limit 0.20, such optical elements as a cover glass and a filter can be inserted between the fourth lens L4 and the image formation plane of the solid-state image sensor, and if the values of f/D does not become below 0.15, various aberrations can be suppressed, and a good image can be obtained.

Since sufficient back focus can be secured for the wide-angle lens of this invention, as mentioned above, rays that enter the light receiving plane of the image sensor enter at approximately a vertical angle throughout the entire center portion to the edge portion of the image. Therefore generation of the above mentioned shading phenomena can be prevented.

By repeated simulations and prototyping, it was confirmed how to set the relationship between the Abbe number of the material of the second lens, which is disposed in the second place from the object, and the Abbe number of the material of the third lens, which is disposed in the third place from the object, in order to obtain a wide-angle with which ideal images can be obtained, under the condition that the second lens L2 is a meniscus lens having positive refractive power of which convex surface facing the image, and conditions on optical length given by the expression (1).

As a result, it was discovered that a wide-angle lens with which ideal images are obtained can be implemented by satisfying the above mentioned conditional expressions (2) and (3).

The conditional expression (2) specifies a range of the values that the Abbe number of the material of the second lens L2 should be. The conditional expression (3) specifies a range of values that the Abbe number of the material of the third lens L3 should be. If the second lens L2 is formed using a lens material of which the Abbe number does not exceed 40, that is the upper limit value of the conditional expression (2), and the third lens L3 is formed using a lens material of which the Abbe number is not below 50, that is the lower limit values of the conditional expression (3), then dispersion of the focal position due to the difference of wavelength, that is the longitudinal chromatic aberration can be suppressed, and ideal images can be easily obtained.

Abbe number 23, which is the lower limit value of the conditional expression (2), and Abbe number 85, which is the upper limit value of the conditional expression (3), are the values determined considering lens materials which are currently (as of the time of application of the present patent) available for purchase as products on the market.

Embodiments of the present invention will now be described with reference to FIG. 1 to FIG. 20. The cross-sectional view of the lens merely depicts the general shape, size and positional relationship of the composing elements only to assist in understanding the present invention. The numerical conditions and other conditions to be described hereinbelow are merely disclosures of some of the best modes, and the present invention is in no way limited to these embodiments of the invention.

### First Embodiment

FIG. 1 is a diagram depicting a configuration of a wide-angle lens according to an embodiment of this invention. The symbols of the surface number, surface distance or the like defined in FIG. 1 are commonly used for FIG. 2, FIG. 6, FIG. 10 and FIG. 14. In FIG. 1, the aperture portion of the aperture stop is indicated as a segment. This is because in order to define the distance from the lens surface to the aperture stop surface, the intersection of the aperture stop surface and the optical axis must be clearly indicated. In FIG. 2, FIG. 6, FIG. 10 and FIG. 14, which are optical path diagrams of the imaging lenses of Example 1-1 to Example 1-4 respectively, the aperture portion of the aperture stop is opened, and the main body of the aperture stop, for blocking light, is illustrated using a half line starting at the edge of the aperture portion, unlike FIG. 1. This is because the aperture portion of the aperture stop must be shown in an opened state, in order to draw such rays as the principal rays reflecting the actual state of the aperture stop.

In the lens configuration depicted in FIG. 1, FIG. 2, FIG. 6, FIG. 10 and FIG. 14, the lenses disposed in the first, second, third and fourth places counted from the object, which are the first lens L1, the second lens L2, the third lens L3 and the fourth lens L4, are denoted as L1, L2, L3 and L4 respectively. 10 denotes a solid-state image sensor constituting a light receiving plane to be an image formation plane, CG denotes a cover glass that separates between the solid-state image sensor and the lens system, and S denotes the aperture stop. The thickness of the aperture stop S can be ignored, and the plane constituting the aperture stop S is denoted as r₇. In a range where no misunderstanding occurs, rᵢ (i=1, 2, 3, . . . , 11) is used as a variable, which refers to a value of a radius of curvature on the optical axis (axial radius of curvature), and is also used as a symbol to identify a lens, a cover glass or an imaging plane (e.g. r₁ is used for indicating the object side surface of the first lens).

Concrete values of rᵢ (i=1, 2, 3, . . . , 11), dᵢ (i=1, 2, 3, . . . , 11) and other parameters shown in FIG. 1 are listed in Table 1-1, Table 2-1, Table 3-1 and Table 4-1. Subscript i corresponds to the surface number of each lens, thickness of each lens, surface distance of each lens or the like, in order from the object to the image. In other words:

rᵢ is an axial radius of curvature of the i-th surface,
dᵢ is a distance from the i-th surface to the (i+1)-th surface,
nᵢ is a refractive index of a material of the lens having the i-th surface and the (i+1)-th surface, and
νᵢ is an Abbe number of a material of a lens having the i-th surface and the (i+1)-th surface.

Since the surface r₇ of the aperture stop S and both surfaces r₁₀ and r₁₁ of the cover glass are planes, the radius of curvature thereof is indicated as ∞. The value of rᵢ (i=1, 2, 3, . . . , 11) of the axial radius of curvature is a positive value if the surface is convex to the object side, and is a negative value if the surface is convex to the image side.

The optical length D is a value generated by adding the back focus bf to the total of d₁ to d₈. The back focus bf is a distance from the image side surface of the fourth lens L4 to the imaging plane on the optical axis. The back focus bf is assumed to be measured without the cover glass CG, which is inserted between the fourth lens L4 and the imaging plane. In other words, a geometric distance (geometric length) must be changed to make the optical distance (optical path length) from the image side surface of the fourth lens L4 to the imaging plane the same, whether the cover glass is inserted or not. This is because the refractive index of the cover glass CG is higher than 1, and the optical path length of the space where the cover glass CG exists is longer than the geometric length. How much the optical path length is longer than the geometric length is determined depending on the refractive index and the thickness of the cover glass CG to be inserted. Therefore in order to define the back focus bf as a value unique to the wide-angle lens which does not depend on whether or not the cover glass CG exists, a value measured without the cover glass is used.

The aspherical data is listed together with the surface number in each column of Table 1-2, Table 2-2, Table 3-2 and Table 4-2.

The aspherical surface used in this invention is given by the following expression:

Z=ch²/[1+{1−(1+k)c²h²}^{+1/2}]+A₄h⁴+A₆h⁶+A₈h⁸+A₁₀h¹⁰+A₁₂h¹²+A₁₄h¹⁴+A₁₆h¹⁶

where
z: depth from the tangential plane at the vertex of the surface
c: paraxial curvature of the surface
h: height from the optical axis
k: conical constant
A₄: aspherical coefficient of degree 4
A₆: aspherical coefficient of degree 6
A₈: aspherical coefficient of degree 8
A₁₀: aspherical coefficient of degree 10
A₁₂: aspherical coefficient of degree 12
A₁₄: aspherical coefficient of degree 14
A₁₆: aspherical coefficient of degree 16

In Table 1-2, Table 2-2, Table 3-2 and Table 4-2, a value indicating the aspherical coefficient is given by an exponential representation, and “e-1”, for example, indicates “10⁻¹”. The focal length f of the wide-angle lens has been normalized to 1.0 mm.

The wide-angle lenses of Examples 1-1 to 1-4 will now be described with reference to FIG. 2 to FIG. 17. FIG. 2, FIG. 6, FIG. 10 and FIG. 14 are schematic diagrams illustrating the wide-angle lenses of Examples 1-1 to 1-4 respectively.

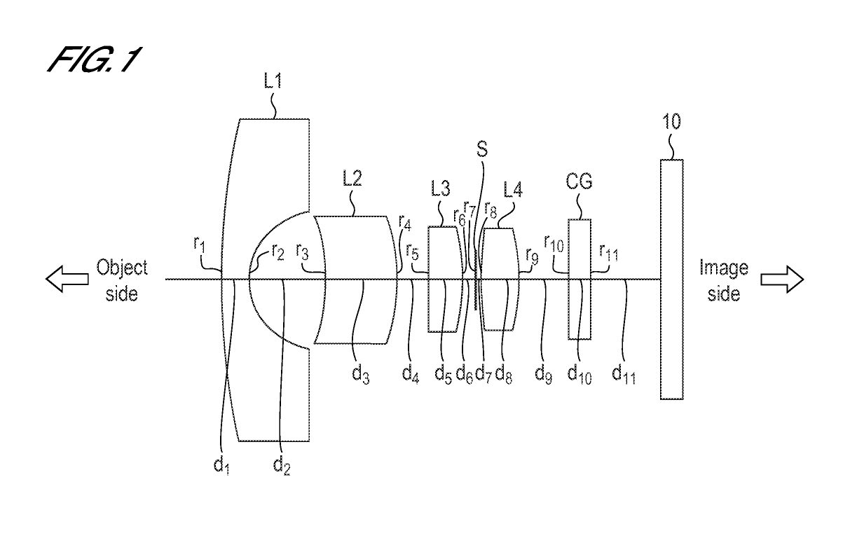

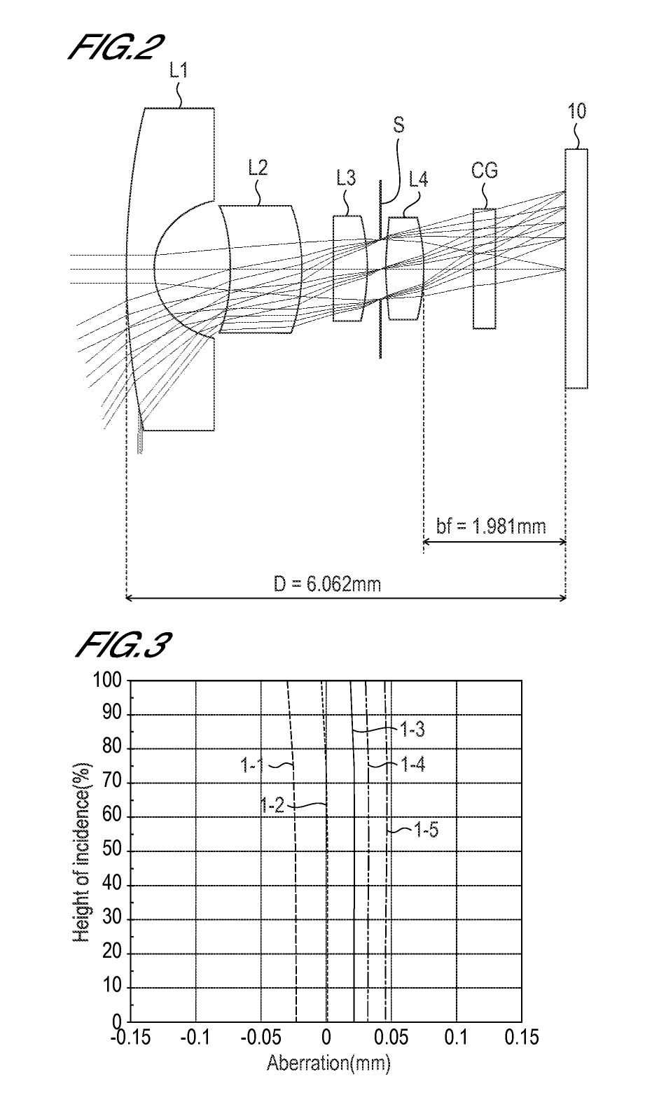

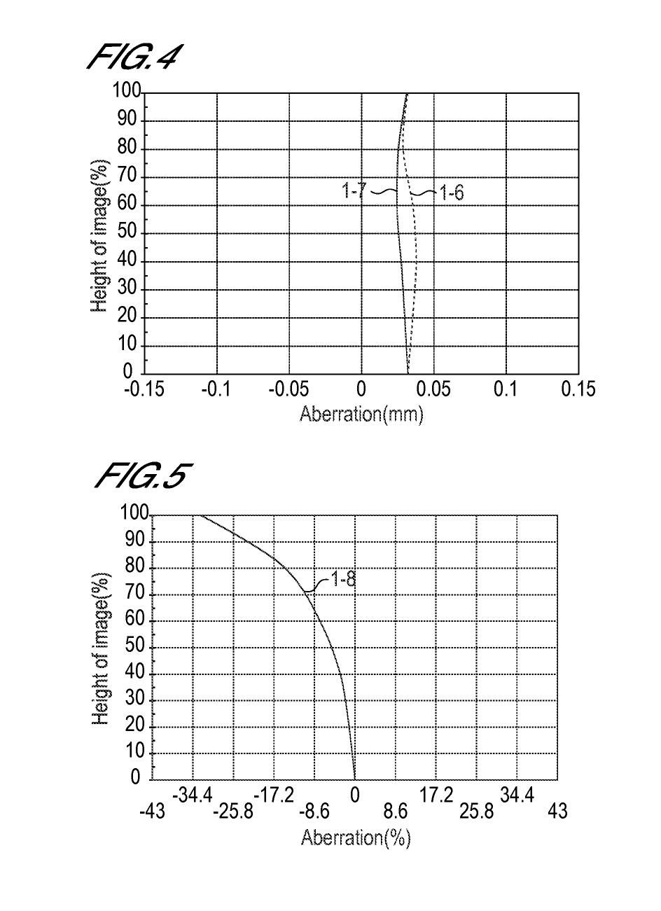

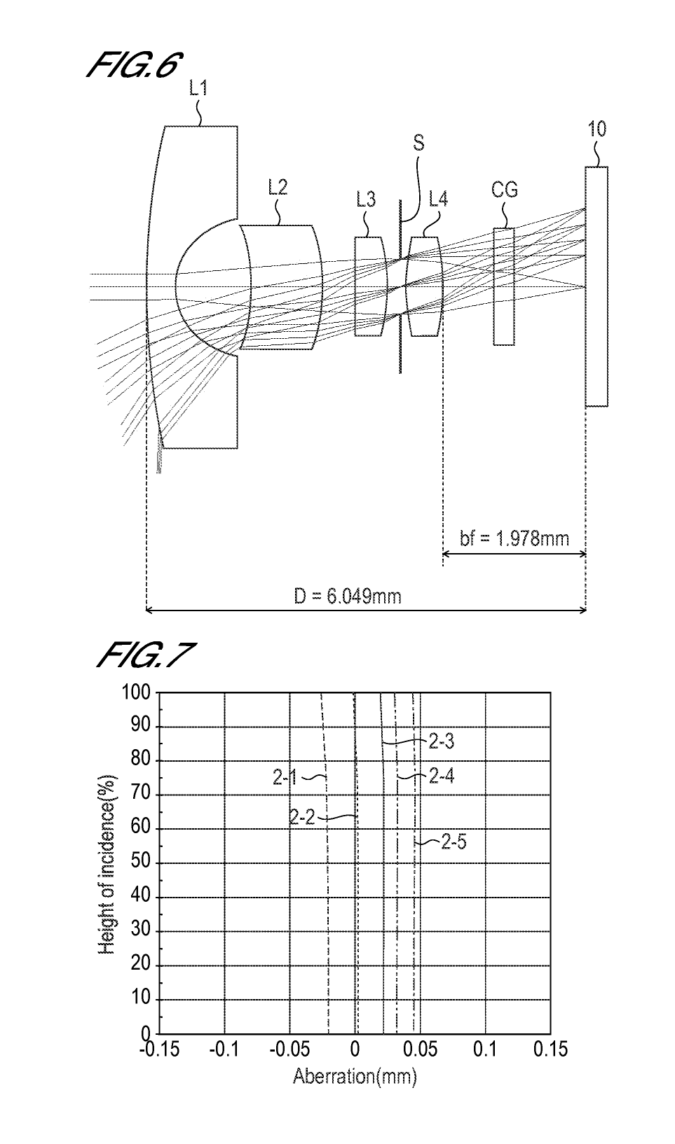

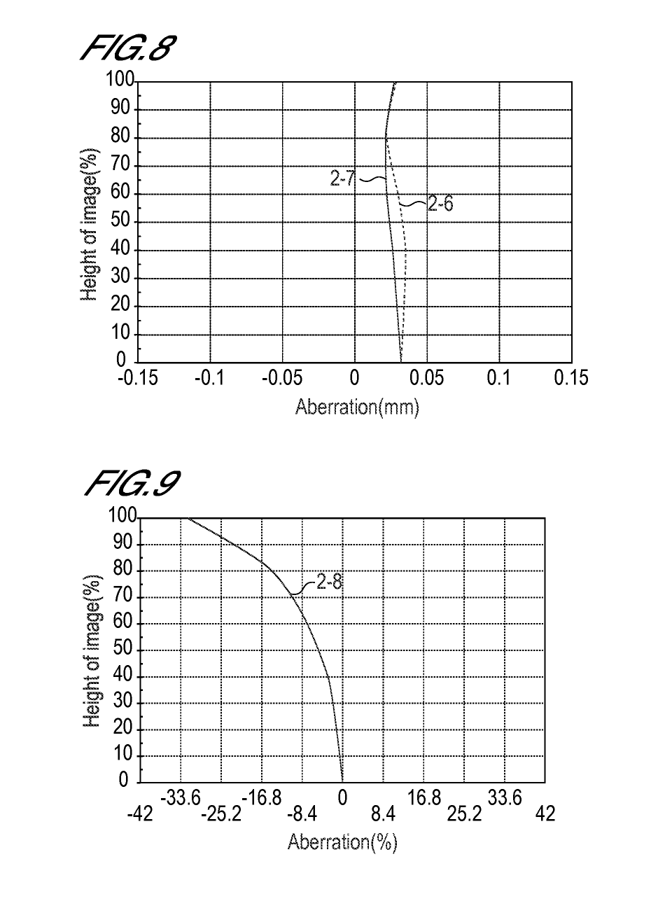

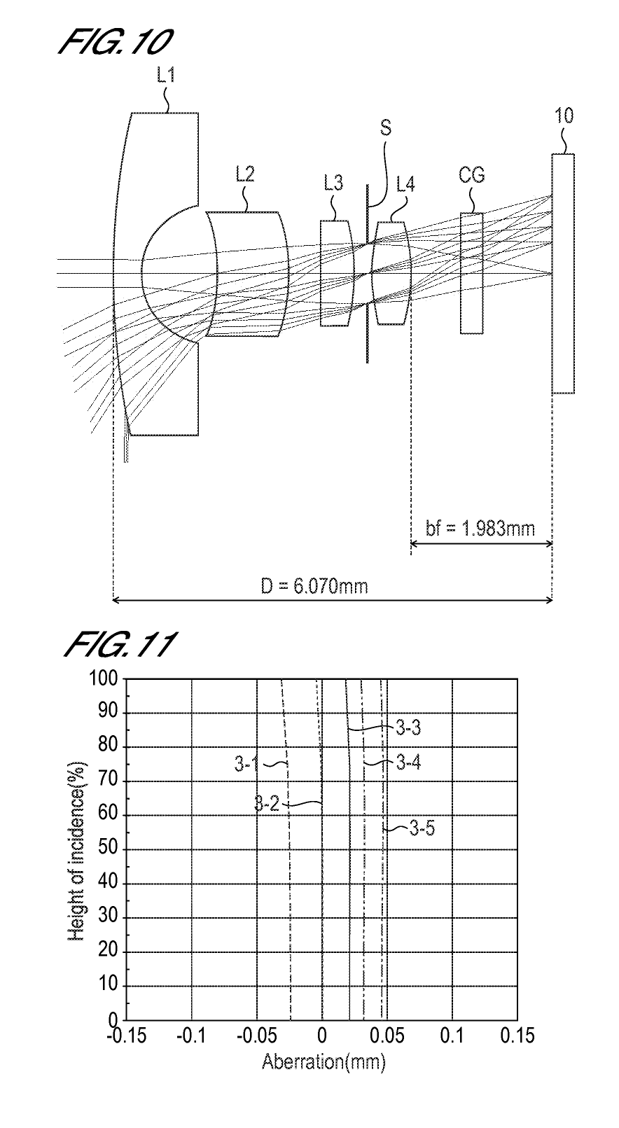

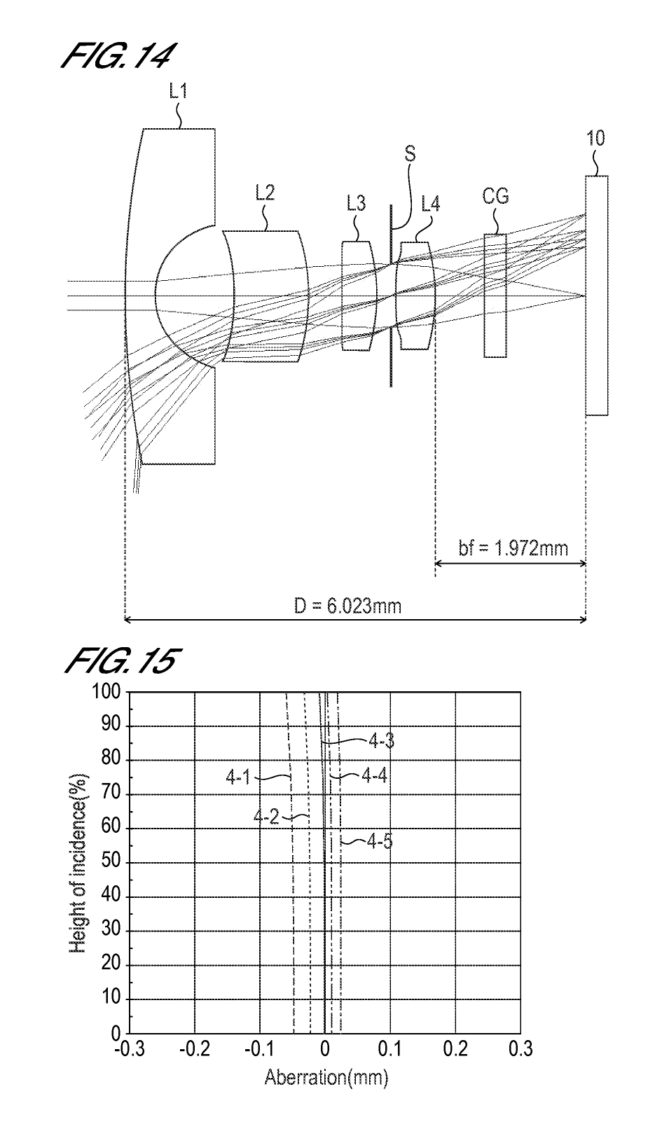

The chromatic/spherical aberration curves shown in FIG. 3, FIG. 7, FIG. 11 and FIG. 15 indicate aberration values at C-line (wavelength: 656.3 nm), d-line (wavelength: 587.6 nm), e-line (wavelength: 546.1 nm), F-line (wavelength: 486.1 nm) and g-line (wavelength: 435.8 nm). The refractive index is a refractive index value at d-line (587.6 nm).

In FIG. 3, FIG. 7, FIG. 11 and FIG. 15, chromatic/spherical aberration (mm) is plotted on the abscissa, with respect to the height of incidence h plotted on the ordinate. The height of incidence h plotted on the ordinate has been converted into F numbers. In the case of the lenses of Example 1-1 and Example 1-3 of which F number is 2.60, the height of incidence h=100% on the ordinate corresponds to F=2.60. In the case of the lens of Example 1-2 of which F number is 2.82, the height of incidence h=100% on the ordinate corresponds to F=2.82, and in the case of the lens of Example 1-4 of which F number is 2.80, the height of incidence h=100% on the ordinate corresponds to F=2.80.

Just like the distortion curve, in the astigmatism curve shown in FIG. 4, FIG. 8, FIG. 12 and FIG. 16, the astigmatism (mm) is plotted on the abscissa with respect to the distance from the optical axis, and aberrations (mm) on the meridional surface and sagittal surface are shown.

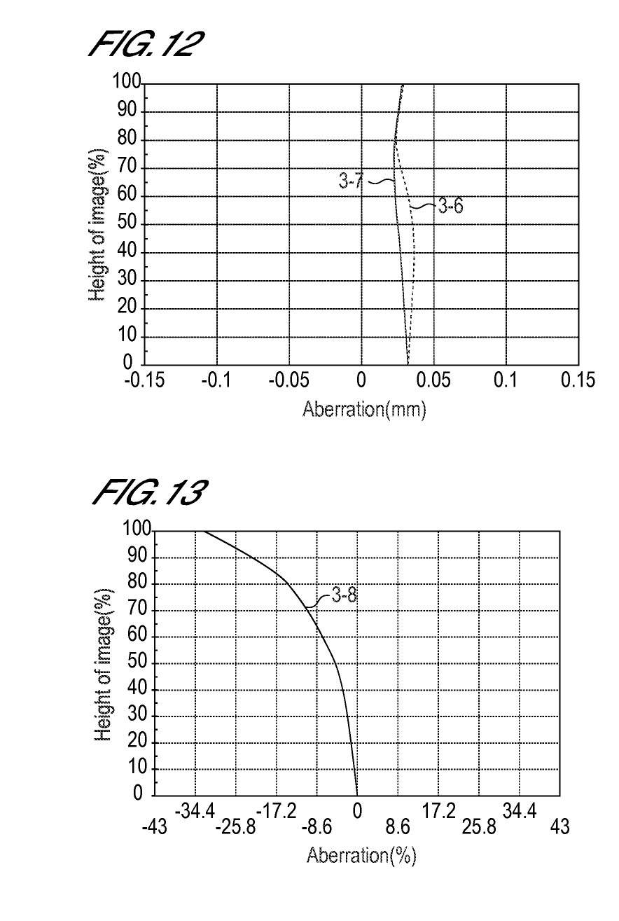

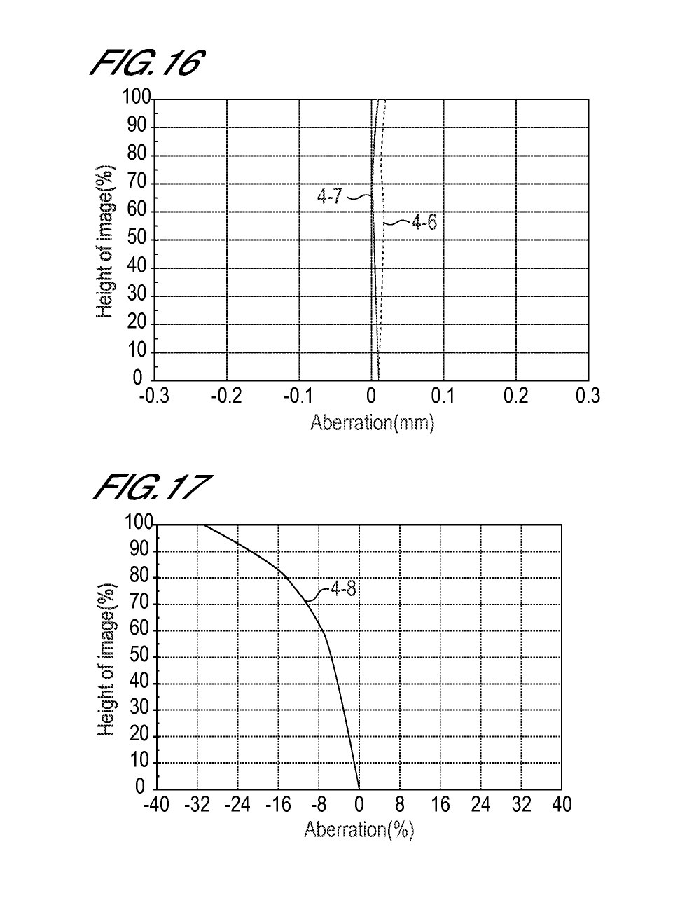

In the distortion curve shown in FIG. 5, FIG. 9, FIG. 13 and FIG. 17, distortion (unsatisfactory amount of the tangent conditions is indicated as a percentage on the abscissa) is plotted with respect to the distance from the optical axis (indicated as percentage on the ordinate where maximum distance from the optical axis in the image plane is 100).

TABLE 1-1

| Radius of | | Refractive | Abbe |
|---|---|---|---|
| Curvature(rᵢ) | Distance(dᵢ) | index(nᵢ) | Number(νᵢ) |
| r₁ = 10.5617 | | 1.5120 | 57.00 |
| | d₁ = 0.3885 | | |
| r₂ = 0.9396 | | | |
| | d₂ = 1.0357 | | |
| r₃ = −6.0756 | | 1.6110 | 26.00 |
| | d₃ = 0.9827 | | |
| r₄ = −4.0304 | | | |
| | d₄ = 0.4420 | | |
| r₅ = 18.7926 | | 1.5120 | 57.00 |
| | d₅ = 0.4609 | | |
| r₆ = −2.2205 | | | |
| | d₆ = 0.1837 | | |
| s = ∞ | | | |
| | d₇ = 0.0630 | | |
| r₈ = 2.9648 | | 1.6030 | 60.70 |
| | d₈ = 0.5249 | | |
| r₉ = −2.9648 | | | |
| | d₉ = 0.6922 | | |
| r₁₀ = ∞ | | 1.5168 | 64.17 |
| | d₁₀ = 0.2887 | | |
| r₁₁ = ∞ | | | |
| | d₁₁ = 1.0000 | | |

TABLE 1-2

| Surface | Aspherical Coefficient | | | | | | | |
|---|---|---|---|---|---|---|---|---|
| number(i) | k | A₄ | A₆ | A₈ | A₁₀ | A₁₂ | A₁₄ | A₁₆ |
| i = 3 | −1.840000e+2 | −2.232998e−1 | 1.369838e−1 | −2.241585e−1 | 5.418780e−2 | 1.340572e−12 | 0 | 0 |
| i = 4 | 0 | −1.119956e−1 | 4.089442e−2 | −8.321723e−2 | 9.482865e−2 | 2.305592e−15 | 0 | 0 |
| i = 5 | 3.340000e+2 | −8.918167e−2 | 1.497790e−1 | −4.470423e−1 | 8.755956e−1 | 6.582951e−16 | 1.082653e−17 | 1.806257e−19 |
| i = 6 | −1.91 | −1.596974e−3 | 1.128987e−1 | −6.063750e−1 | 1.417474 | −1.558804e−16 | 0 | 0 |

TABLE 2-1

| Radius of | | Refractive | Abbe |
|---|---|---|---|
| Curvature(rᵢ) | Distance(dᵢ) | index(nᵢ) | Number(νᵢ) |
| r₁ = 10.5925 | | 1.5120 | 57.00 |
| | d₁ = 0.3907 | | |
| r₂ = 0.9439 | | | |
| | d₂ = 1.0349 | | |
| r₃ = −6.0692 | | 1.6110 | 26.00 |
| | d₃ = 0.9816 | | |
| r₄ = −4.0262 | | | |
| | d₄ = 0.4415 | | |
| r₅ = 18.7729 | | 1.5120 | 57.00 |
| | d₅ = 0.4604 | | |
| r₆ = −2.2181 | | | |
| | d₆ = 0.1835 | | |
| s = ∞ | | | |
| | d₇ = 0.0640 | | |
| r₈ = 2.9617 | | 1.6030 | 65.44 |
| | d₈ = 0.5139 | | |
| r₉ = −2.9617 | | | |
| | d₉ = 0.6900 | | |
| r₁₀ = ∞ | | 1.5168 | 64.17 |
| | d₁₀ = 0.2884 | | |
| r₁₁ = ∞ | | | |
| | d₁₁ = 1.0000 | | |

TABLE 2-2

| Surface | Aspherical Coefficient | | | | | | | |
|---|---|---|---|---|---|---|---|---|
| number(i) | k | A₄ | A₆ | A₈ | A₁₀ | A₁₂ | A₁₄ | A₁₆ |
| i = 1 | −1.000000e−1 | 5.180537e−4 | −7.994959e−5 | −1.192348e−6 | 9.973182e−7 | 0 | 0 | 0 |
| i = 3 | −1.840000e+2 | −2.240045e−1 | 1.377050e−1 | −2.258124e−1 | 5.470240e−2 | 1.356148e−12 | 0 | 0 |
| i = 4 | 0 | −1.123490e−1 | 4.110973e−2 | −8.383126e−2 | 9.572921e−2 | 2.332381e−15 | 0 | 0 |
| i = 5 | 3.340000e+2 | −8.946309e−2 | 1.505675e−1 | −4.503408e−1 | 8.839108e−1 | 6.659440e−16 | 1.097535e−17 | 1.834936e−19 |
| i = 6 | −1.91 | −1.602013e−3 | 1.134931e−1 | −6.108492e−1 | 1.430935 | −1.576917e−16 | 0 | 0 |

TABLE 3-1

| Radius of | | Refractive | Abbe |
|---|---|---|---|
| Curvature(rᵢ) | Distance(dᵢ) | index(nᵢ) | Number(νᵢ) |
| r₁ = 10.5567 | | 1.51633 | 64.14 |
| | d₁ = 0.3913 | | |
| r₂ = 0.9454 | | | |
| | d₂ = 1.0362 | | |
| r₃ = −6.0788 | | 1.61100 | 26.00 |
| | d₃ = 0.9832 | | |
| r₄ = −4.0326 | | | |
| | d₄ = 0.4422 | | |
| r₅ = 18.8025 | | 1.51200 | 57.00 |
| | d₅ = 0.4611 | | |
| r₆ = −2.2216 | | | |
| | d₆ = 0.1838 | | |
| s = ∞ | | | |
| | d₇ = 0.0641 | | |
| r₈ = 2.9664 | | 1.60300 | 60.70 |
| | d₈ = 0.5252 | | |
| r₉ = −2.9664 | | | |
| | d₉ = 0.6941 | | |
| r₁₀ = ∞ | | 1.51680 | 64.17 |
| | d₁₀ = 0.2889 | | |
| r₁₁ = ∞ | | | |
| | d₁₁ = 1.0000 | | |

TABLE 3-2

| Surface | Aspherical Coefficient | | | | | | | |
|---|---|---|---|---|---|---|---|---|
| number(i) | k | A₄ | A₆ | A₈ | A₁₀ | A₁₂ | A₁₄ | A₁₆ |
| i = 3 | −1.840000e+2 | −2.229480e−1 | 1.366242e−1 | −2.233352e−1 | 5.393206e−2 | 1.332843e−12 | 0 | 0 |
| i = 4 | 0 | −1.118191e−1 | 4.078709e−2 | −8.291160e−2 | 9.438110e−2 | 2.292299e−15 | 0 | 0 |
| i = 5 | 3.340000e+2 | −8.904115e−2 | 1.493858e−1 | −4.454004e−1 | 8.714631e−1 | 6.544998e−16 | 1.075280e−17 | 1.792071e−19 |
| i = 6 | −1.91 | −1.594458e−3 | 1.126024e−1 | −6.041480e−1 | 1.410784 | −1.549817e−16 | 0 | 0 |

TABLE 4-1

| Radius of | | Refractive | Abbe |
|---|---|---|---|
| Curvature(rᵢ) | Distance(dᵢ) | index(nᵢ) | Number(νᵢ) |
| r₁ = 10.4846 | | 1.51200 | 57.00 |
| | d₁ = 0.3856 | | |
| r₂ = 0.9328 | | | |
| | d₂ = 1.0281 | | |
| r₃ = −6.0313 | | 1.61100 | 26.00 |
| | d₃ = 0.9755 | | |
| r₄ = −4.0010 | | | |
| | d₄ = 0.4388 | | |
| r₅ = 18.6555 | | 1.51200 | 57.00 |
| | d₅ = 0.4575 | | |
| r₆ = −2.2043 | | | |
| | d₆ = 0.1824 | | |
| s = ∞ | | | |
| | d₇ = 0.0625 | | |
| r₈ = 2.6055 | | 1.53000 | 56.00 |
| | d₈ = 0.5211 | | |
| r₉ = −2.6055 | | | |
| | d₉ = 0.6382 | | |
| r₁₀ = ∞ | | 1.51680 | 64.17 |
| | d₁₀ = 0.2866 | | |
| r₁₁ = ∞ | | | |
| | d₁₁ = 1.0471 | | |

TABLE 4-2

| Surface | Aspherical Coefficient | | | | | | | |
|---|---|---|---|---|---|---|---|---|
| number(i) | k | A₄ | A₆ | A₈ | A₁₀ | A₁₂ | A₁₄ | A₁₆ |
| i = 3 | −1.840000e+2 | −2.282588e−1 | 1.420913e−1 | −2.359461e−1 | 5.787868e−2 | 1.453003e−12 | 0 | 0 |
| i = 4 | 0 | −1.144827e−1 | 4.241920e−2 | −8.759333e−2 | 1.012877e−1 | 2.498957e−15 | 0 | 0 |
| i = 5 | 3.340000e+2 | −9.116217e−2 | 1.553636e−1 | −4.705506e−1 | 9.352348e−1 | 7.135051e−16 | 1.190762e−17 | 2.015927e−19 |
| i = 6 | −1.91 | −1.632439e−3 | 1.171082e−1 | −6.382621e−1 | 1.514022 | −1.689539e−16 | 0 | 0 |

Materials of single lenses constituting the wide-angle lenses according to Examples 1-1 to 1-4 will be described.

In Example 1-1, synthetic resin Arton (Arton is a registered trademark of JSR Corporation), which is cycloolefin plastic, is used for the lens material of the first lens L1 and the third lens L3. Synthetic resin SD1414 (SD1414 is a product ID number of Teijin Chemicals Ltd.), which is polycarbonate plastic, is used for the lens material of the second lens L2. BACD14 (BACD14 is a product ID number of Hoya Corporation), which is crown glass, is used for the lens material of the fourth lens L4.

In Example 1-2, the synthetic resin Arton®, which is cycloolefin plastic, is used for the lens material of the first lens L1 and the third lens L3. The synthetic resin SD1414, which is polycarbonate plastic, is used for the lens material of the second lens L2. And S-PHM53 (S-PHM53 is a product ID number of Ohara Inc.), which is crown glass, is used for the lens material of the fourth lens L4.

In Example 1-3, BSC7 (BSC7 is a product ID number of Hoya Corporation), which is crown glass, is used for the lens material of the first lens L1. The synthetic resin SD1414, which is polycarbonate plastic, is used for the lens material of the second lens L2. The synthetic resin Arton®, which is cycloolefin plastic, is used for the lens material of the third lens L3. BACD14, which is crown glass, is used for the lens material of the fourth lens L4.

In Example 1-4, the synthetic resin Arton®, which is cycloolefin plastic, is used for the lens material of the first lens L1 and the third lens L3. The synthetic resin SD1414, which is polycarbonate plastic, is used for the lens material of the second lens L2. The synthetic resin E48R (E48R is a product ID number of Zeon Corporation), which is cycloolefin plastic, is used for the lens material of the fourth lens L4.

The refractive index of Arton® at d-line is 1.5120 and the Abbe number thereof is 57.00, the refractive index of SD1414 at d-line is 1.6110 and the Abbe number thereof is 26.00, the refractive index of BACD14 at d-line is 1.6030 and the Abbe number thereof is 60.70, the refractive index of S-PHM53 at d-line is 1.6030 and the Abbe number thereof is 65.44, the refractive index of BSC7 at d-line is 1.51633 and the Abbe number thereof is 64.14, and the refractive index of E48R at d-line is 1.5300 and the Abbe number thereof is 56.00.

A cover glass CG is inserted between the fourth lens L4 and the solid-state image sensor 10. The material of the cover glass CG is optical glass BK7 (made by Hoya Corporation), of which refractive index at d-line is 1.51680 and Abbe number is 64.17. Various aberrations to be described below are calculated assuming that these filters exist.

### Example 1-1

FIG. 2 is a cross-sectional view depicting a wide-angle lens according to Example 1-1. As FIG. 2 illustrates, the wide-angle lens of Example 1-1 comprises, in order from the object to the image, a first lens L1, a second lens L2, a third lens L3, an aperture stop S and a fourth lens L4.

The first lens L1 is meniscus lens having negative refractive power, of which convex surface faces the object. The second lens L2 is a meniscus lens having positive refractive power, of which convex surface faces the image. The third lens L3 and the fourth lens L4 are lenses having positive refractive power. Both surfaces of the second lens L2 and both surfaces of the third lens L3 are aspherical. As FIG. 2 illustrates, in the wide-angle lens of Example 1-1, the back focus bf with respect to the focal length 1.00 mm is 1.981 mm in a state where the cover glass CG is inserted. In other words, a sufficient length of back focus is secured.

The full aperture F number is 2.60, that is, the implemented wide-angle lens is sufficiently bright as a wide-angle lens.

The characteristics of the wide-angle lens of Example 1-1 are as follows:

(A) The combined focal length is 1.00 mm.
(B) The optical length D is D=6.062 mm, as illustrated in FIG. 2.
(C) The Abbe number ν_{d2} of the second lens L2 is ν_{d2}=ν₃=26.0, as shown in Table 1-1.
(D) The Abbe number ν_{d3} of the third lens L3 is ν_{d3}=ν₅=57.0, as shown in Table 1-1.

### Therefore,

f/D=1.00/5.96=0.1678 (1)

ν_{d2}=26.0 (2)

ν_{d3}=57.0 (3)

which means that the wide-angle lens of Example 1-1 satisfies all of the following conditional expressions (1) to (3).

0.15≦f/D≦0.20 (1)

23≦ν_{d2}≦40 (2)

85≧ν_{d3}≧50 (3)

FIG. 3 is a graph of chromatic/spherical aberration curves (aberration curve 1-1 is at g-line, aberration curve 1-2 is at F-line, aberration curve 1-3 is at e-line, aberration curve 1-4 is at d-line, and aberration curve 1-5 is at C-line), FIG. 4 is a graph of astigmatism curves (aberration curve 1-6 is on the meridional surface and aberration curve 1-7 is on the sagittal surface), and FIG. 5 is a graph of a distortion curve 1-8.

The ordinate of the aberration curve in FIG. 3 indicates the height of incidence h (F number), and the maximum value corresponds to F 2.60. The ordinate indicates a percentage with respect to the distance from the optical axis, and the abscissa indicates the aberration value in mm units. The ordinates of the aberration curves in FIG. 4 and FIG. 5 indicate the height of image, where 100%, 80%, 60%, 40% and 0% correspond to 1.07 mm, 0.856 mm, 0.642 mm, 0.428 mm and 0 mm respectively.

For the chromatic/spherical aberration, the absolute value of the aberration curve 1-5 at C-line is 0.0467 mm, which is the maximum, when the height of incidence h is 75%, and the absolute value of the aberration is within 0.0467 mm.

For astigmatism, the absolute value of the aberration curve 1-6 on the meridional surface is 0.0378 mm, which is the maximum, when the height of image is 40% (height of image: 0.428 mm), and the absolute value of the aberration is within 0.0378 mm when the height of image is 1.07 mm or less.

For distortion, the absolute value of the aberration curve 1-8 is 98.1753%, which is the maximum, when the height of image is 100% (height of image: 1.07 mm), and the absolute value of the aberration is within 98.1753% when the height of image is 1.07 mm or less.

### Example 1-2

FIG. 6 is a cross-sectional view depicting a wide-angle lens according to Example 1-2. As FIG. 6 illustrates, the wide-angle lens of Example 1-2 comprises, in order from the object to the image, a first lens L1, a second lens L2, a third lens L3, an aperture stop S and a fourth lens L4.

The first lens L1 is a meniscus lens having negative refractive power, of which convex surface faces the object. The second lens L2 is a meniscus lens having positive refractive power, of which convex surface faces the image. The third lens L3 and the fourth lens L4 are lenses having positive refractive power. The object side surface of the first lens L1, both surfaces of the second lens L2, and both surfaces of the third lens L3, are aspherical. As FIG. 6 illustrates, in the wide-angle lens of Example 1-2, the back focus bf with respect to the focal length 1.00 mm is 1.978 mm in a state where the cover glass CG is inserted, in other words, sufficient length of back focus is secured.

The full aperture F number is 2.82, that is, the implemented wide-angle lens is sufficiently bright as a wide-angle lens.

The characteristics of the wide-angle lens of Example 1-2 are as follows:

(A) The combined focal length is 1.00 mm.
(B) The optical length D is D=6.049 mm, as illustrated in FIG. 6.
(C) The Abbe number ν_{d2} of the second lens L2 is ν_{d2}=ν₃=26.0, as shown in Table 2-1.
(D) The Abbe number ν_{d3} of the third lens L3 is ν_{d3}=ν₅=57.0, as shown in Table 2-1.

### Therefore,

f/D=1.00/5.95=0.1681 (1)

ν_{d2}=26.0 (2)

ν_{d3}=57.0 (3)

which means that the wide-angle lens of Example 1-2 satisfies all of the following conditional expressions (1) to (3).

0.15≦f/D≦0.20 (1)

23≦ν_{d2}≦40 (2)

85≧ν_{d3}≧50 (3)

FIG. 7 is a graph of chromatic/spherical aberration curves (aberration curve 2-1 is at g-line, aberration curve 2-2 is at F-line, aberration curve 2-3 is at e-line, aberration curve 2-4 is at d-line, and aberration curve 2-5 is at C-line), FIG. 8 is a graph of astigmatism curves (aberration curve 2-6 is on the meridional surface, and aberration curve 2-7 is on the sagittal surface), and FIG. 9 is a graph of a distortion curve 2-8.

The ordinate of the aberration curve in FIG. 7 indicates the height of incident h (F number) and the maximum value corresponds to F 2.82. The ordinate indicates a percentage with respect to the distance from the optical axis, and the abscissa indicates the aberration value in mm units. The ordinates of the aberration curves in FIG. 8 and FIG. 9 indicate the height of image, where 100%, 80%, 60%, 40% and 0% correspond to 1.07 mm, 0.856 mm, 0.642 mm, 0.428 mm and 0 mm respectively.

For the chromatic/spherical aberration, the absolute value of the aberration curve 2-5 at C-line is 0.0460 mm, which is the maximum, when the height of incidence h is 100%, and the absolute value of the aberration is within 0.0460 mm.

For astigmatism, the absolute value of the aberration curve 2-6 on the meridional surface is 0.0351 mm, which is the maximum, when the height of image is 40% (height of image: 0.428 mm), and the absolute value of the aberration is within 0.0351 mm when the height of image is 1.07 mm or less.

For distortion, the absolute value of the aberration curve 2-8 is 96.6152%, which is the maximum, when the height of an image is 100% (height of image: 1.07 mm), and the absolute value of the aberration is within 96.6152% when the height of image is 1.07 mm or less.

### Example 1-3

FIG. 10 is a cross-sectional view depicting a wide-angle lens according to Example 1-3. As FIG. 10 illustrates, the wide-angle lens of Example 1-3 comprises, in order from the object to the image, a first lens L1, a second lens L2, a third lens L3, an aperture stop S and a fourth lens L4.

The first lens L1 is a meniscus lens having negative refractive power, of which convex surface faces the object. The second lens L2 is a meniscus lens having positive refractive power, of which convex surface faces the image. The third lens L3 and the fourth lens L4 are lenses having positive refractive power. The object side surface of the first lens L1, both surfaces of the second lens L2 and both surfaces of the third lens L3 are aspherical. As FIG. 10 illustrates, in the wide-angle lens of Example 1-3, the back focus bf with respect to the focal length 1.00 mm is 1.983 mm in a state where the cover glass CG is inserted, in other words, sufficient length of back focus is secured.

The full aperture F number is 2.60, that is the implemented wide-angle lens is sufficiently bright as a wide-angle lens.

The characteristics of the wide-angle lens of Example 1-3 are as follows:

(A) The combined focal length is 1.00 mm.
(B) The optical length D is D=6.070 mm, as illustrated in FIG. 6.
(C) The Abbe number ν_{d2} of the second lens L2 is ν_{d2}=ν₃=26.0, as shown in Table 3-1.
(D) The Abbe number ν_{d3} of the third lens L3 is ν_{d3}=ν₅=57.0, as shown in Table 3-1.

Therefore,

f/D=1.00/5.97=0.1675 (1)

ν_{d2}=26.0 (2)

ν_{d3}=57.0 (3)

which means that the wide-angle lens of Example 1-2 satisfies all of the following conditional expressions (1) to (3).

0.15≦f/D≦0.20 (1)

23≦ν_{d2}≦40 (2)

85≧ν_{d3}≧50 (3)

FIG. 11 is a graph of chromatic/spherical aberration curves (aberration curve 3-1 is at g-line, aberration curve 3-2 is at F-line, aberration curve 3-3 is at e-line, aberration curve 3-4 is at d-line, and aberration curve 3-5 is at C-line), FIG. 12 is a graph of astigmatism curves (aberration curve 3-6 is on the meridional surface, and aberration curve 3-7 is on the sagittal surface), and FIG. 13 is a graph of a distortion curve 3-8.

The ordinate of the aberration curve in FIG. 11 indicates the height of incidence h (F number) and the maximum value corresponds to F 2.60. The ordinate indicates a percentage with respect to the distance from the optical axis, and the abscissa indicates the aberration value in mm units. The ordinates of the aberration curves in FIG. 12 and FIG. 13 indicate the height of image, where 100%, 80%, 60%, 40% and 0% correspond to 1.07 mm, 0.856 mm, 0.642 mm, 0.428 mm and 0 mm respectively.

For the chromatic/spherical aberration, the absolute value of the aberration curve 3-5 at C-line is 0.0469 mm, which is the maximum, when the height of incidence h is 100%, and the absolute value of the aberration is within 0.0469 mm.

For astigmatism, the absolute value of the aberration curve 3-6 on the meridional surface is 0.0364 mm, which is the maximum, when the height of image is 40% (height of image: 0.428 mm), and the absolute value of the aberration is within 0.0364 mm when the height of image is 1.07 mm or less.

For distortion, the absolute value of the aberration is 97.6268%, which is the maximum, when the height of image is 100% (height of image: 1.07 mm), and the absolute value of the aberration curve 3-8 is within 97.6268% when the height of image is 1.07 mm or less.

### Example 1-4

FIG. 14 is a cross-sectional view depicting a wide-angle lens according to Example 1-4. As FIG. 14 illustrates, the wide-angle lens of Example 1-4 comprises, in order from the object to the image, a first lens L1, a second lens L2, a third lens L3, an aperture stop S and a fourth lens L4.

The first lens L1 is a meniscus lens having negative refractive power, of which convex surface faces the object. The second lens L2 is a meniscus lens having positive refractive power, of which convex surface faces the image. The third lens L3 and the fourth lens L4 are lenses having positive refractive power. The object side surface of the first lens L1, both surfaces of the second lens L2 and both surfaces of the third lens L3 are aspherical. As FIG. 14 illustrates, in the wide-angle lens of Example 1-4, the back focus bf with respect to the focal length 1.00 mm is 1.972 mm in a state where the cover glass CG is inserted. In other words, sufficient length of back focus is secured.

The full aperture F number is 2.80, that is the implemented wide-angle lens is sufficiently bright as a wide-angle lens.

The characteristics of the wide-angle lens of Example 1-4 are as follows:

(A) The combined focal length is 1.00 mm.
(B) The optical length D is D=6.023 mm, as illustrated in FIG. 6.
(C) The Abbe number ν_{d2} of the second lens L2 is ν_{d2}=ν₃=26.0, as shown in Table 4-1.
(D) The Abbe number ν_{d3} of the third lens L3 is ν_{d3}=ν₅=57.0, as shown in Table 4-1.

### Therefore,

f/D=1.00/5.93=0.1686 (1)

ν_{d2}=26.0 (2)

ν_{d3}=57.0 (3)

which means that the wide-angle lens of Example 1-2 satisfies all of the following conditional expressions (1) to (3).

0.15≦f/D≦0.20 (1)

23≦ν_{d2}≦40 (2)

85≧ν_{d3}≧50 (3)

FIG. 15 is a graph of chromatic/spherical aberration curves (aberration curve 4-1 is at g-line, aberration curve 4-2 is at F-line, aberration curve 4-3 is at e-line, aberration curve 4-4 is at d-line, and aberration 4-5 is at C-line), FIG. 16 is a graph of astigmatism curves (aberration curve 4-6 is on the meridional surface, and aberration curve 4-7 is on the sagittal surface), and FIG. 17 is a graph of a distortion curve 4-8.

The ordinate of the aberration curve in FIG. 15 indicates the height of incidence h (F number) and the maximum value corresponds to F 2.80. The ordinate indicates a percentage with respect to the distance from the optical axis, and the abscissa indicates the aberration value in mm units. The ordinates of the aberration curves in FIG. 16 and FIG. 17 indicate the height of image, where 100%, 80%, 60%, 40% and 0% correspond to 1.07 mm, 0.856 mm, 0.642 mm, 0.428 mm and 0 mm respectively.

For the chromatic/spherical aberration, the absolute value of the aberration curve 4-1 at g-line is 0.0598 mm, which is the maximum, when the height of incidence h is 100%, and the absolute value of the aberration is within 0.0598 mm.

For astigmatism, the absolute value of the aberration curve 4-6 on the meridional surface is 0.0148 mm, which is the maximum, when the height of image is 70% (height of image: 0.749 mm), and the absolute value of the aberration is within 0.0148 mm when the height of image is 1.07 mm or less.

For distortion, the absolute value of the aberration is 92.2224%, which is the maximum, when the height of image is 100% (height of image: 1.07 mm), and the absolute value of the aberration curve 4-8 is within 92.2224% when the height of image is 1.07 mm or less.

### <Characteristics of Wide-Angle Lens of Example>

As described above, it was confirmed through prototyping that the performance required for a lens enclosed in a compact camera, which uses CCD, CMOS or the like as the image sensor, is guaranteed for all the wide-angle lenses of Examples 1-1 to 1-4.

By designing each lens constituting the wide-angle lens so as to satisfy the conditional expressions (1) to (3), a wide-angle lens where various aberrations are ideally corrected, optical length with respect to the focal length of the wide-angle lens is short, and sufficient back focus is secured, can be implemented.

In the above examples, the first lens L1, the third lens L3 and the fourth lens L4 are formed of cycloolefin optical resin, and the second lens L2 is formed of polycarbonate optical resin, but other optical resin material, or mold glass other than optical resin material, can be used as a material of a single lens constituting the wide-angle lens of this invention if the material can satisfy various conditions described in the examples.

In a portable telephone, for example, not only the cover glass CG mentioned in the examples but also such an element as an infrared cut-off filter may be inserted between the fourth lens L4 and the light receiving plane of the solid-state image sensor, but with the currently available technology (as of the time of this application), these elements can be inserted if 0.95 mm or more is secured between the fourth lens L4 and the light receiving plane of the solid-state image sensor. In order to enclose a wide-angle lens in a current portable telephone or the like, an optical length less than 5 mm is desirable, but all of the wide-angle lenses of the above Examples 1-1 to 1-4 satisfy this condition.

For example, according to the wide-angle lens disclosed in Example 1-1 of this invention, the optical length D is D=6.062 mm when the focal length of the wide-angle lens is normalized to 1.00 mm, so if the optical length is 5 mm, the focal length of the wide-angle lens corresponds to 0.8389 mm. The back focus bf is bf=1.981 mm when the focal length of the wide-angle lens is normalized to 1.00 mm, so if the focal length of the wide-angle lens is 0.8389 mm, the back focus becomes 1.6611 mm, which means that 1.6611 mm or more can be secured for the space between the fourth lens L4 and the light receiving plane of the solid-state image sensor.

The wide-angle lenses of Examples 1-1 to 1-3, of which the fourth lens L4 is formed of optical glass as a material, are suitable wide-angle lenses in the case when it is necessary to minimize the damage to single lenses constituting this wide-angle lens due to heat received from the solid-state image sensor included in the imaging device enclosing the wide-angle lens.

The wide-angle lens of Example 1-3, of which the first lens L1 is formed of optical glass as a material, is also a suitable wide-angle lens when it is expected to be used under a harsh environment, such as in a serious rain storm or sand storm.

The wide-angle lens of Example 1-4 is also a wide-angle lens suitable when the damage resistance of the first lens L1 and the heat resistance of the fourth lens L4 are not demanded as much as in the above mentioned special cases, and therefore can be manufactured in simple manufacturing steps at lower manufacturing cost. According to the lens of this invention, even if the lens is constituted by a small number of lenses such as a four-lens combination, characteristics can be improved, including ideal chromatic aberration correction. Therefore a wide-angle lens that can be used for the various applications mentioned above can be provided.

Although preferred embodiments of the wide-angle lens of the present invention were described, the present invention is not limited to the embodiments, and numerous modifications can be made without departing from the true spirit and scope of the invention, and needless to say, those variant forms are included in the scope of the Claims of the present invention. It is obvious that those skilled in the art could make various modifications and variations within the scope disclosed in the Claims, and it should be understood that these are also within the technical scope of the present invention.

For example, the technical characteristics of the present invention to solve at least one problem is that the wide-angle lens of the present invention is required to be constituted by a least four lenses, and it is easy to understand that the present invention is not limited to be constituted by only four lenses.

### Second Embodiment

The wide-angle lens of this invention can be enclosed in the following systems, for example.

### Example 2-1

A system according to Example 2-1 enclosing the wide-angle lens of an embodiment of the present invention will be described with reference to FIG. 18.

FIG. 18 is a schematic cross-sectional view of a camera module, that is an example of a system having a first semiconductor device which converts optical image information received via any one of the above mentioned wide-angle lenses according to Examples 1-1 to 1-4 into a first electric signal via a semiconductor chip disposed on the image side of this wide-angle lens.

The camera module illustrated in FIG. 18 has an image sensor package 100 including a glass substrate 110 and an image sensor chip 120, a printed circuit board 200 on which the image sensor package 100 is mounted, and a lens housing 300 which is attached to the image sensor package 100.

The image sensor chip 120 converts the optical image information received via the wide-angle lens into the first electric signal, and outputs the first electric signal to the outside. The image sensor package 100 has a connection terminal 114, such as a solder ball, which is created so as to be connected with a metal wiring formed on the glass substrate 110 outside the image sensor chip 120. An IR cut-off filter 130 is coated on the other side of the glass substrate 110, in order to transmit or block light in a predetermined wavelength band. The connection terminal 114 may have a structure to be connected to the image sensor chip 120 without passing through the glass substrate 110.

A conductive pattern is printed on the printed circuit board 200, so as to be electrically connected with the image sensor chip 120 via the connection terminal 114, and supplies drive voltage and current from the outside to the image sensor chip 120. On the other hand, the first electric signal, which is output from the image sensor chip 120, is supplied to the printed circuit board 200. A second semiconductor device to which the first electric signal is supplied, and which generates a second electric signal by processing the first electric signal according to the program, and outputs the second electric signal to the output terminal of the printed circuit board 200, is mounted to the printed circuit board 200. The output terminal of the printed circuit board 200 is connected to an input terminal of a controlled device. The controlled device has a function to perform electrical or mechanical control based on the second electric signal.

A lens mounting portion 330 has a lens holding portion 331 which protrudes horizontally from a predetermined area to the inside, and a lens securing portion 332 which protrudes horizontally from an upper area of the lens housing 300 to the inside.

A protruded portion 340, which protrudes downward at a distance from the extended portion 320, is created inside a horizontal portion 310, and because of this protruded portion 340, a predetermined space is created between the protruded portion 340 and the extended portion 320, and between the glass substrate 110 and the horizontal portion 310, and adhesive 350 is coated in these spaces.

As described above, the system of Example 2-1 has the wide-angle lens 360, which is any one of the wide-angle lenses of Examples 1-1 to 1-4, and has the printed circuit board 200, as the first semiconductor device, which converts the optical image information received via the wide-angle lens 360 into the first electric signal via the image sensor chip 120, which is the semiconductor chip disposed on the image side of the wide-angle lens 360, and outputs the first electric signal.

An example of a camera module to which the above mentioned wide-angle lens can be suitably applied is an image sensor camera module disclosed in Japanese Patent Application Laid-Open No. 2010-141865. The camera module illustrated in FIG. 18 or a similar camera module may be used as a component of an endoscope or medical capsule. Examples of an endoscope to which the camera module illustrated in FIG. 18 or a similar camera module can be suitable applied are endoscopes disclosed in Japanese Translation of PCT Application No. 2008-532574, Japanese Patent Application Laid-Open No. 2010-188153 and Japanese Patent Application Laid-Open No. 2009-178568. An example of the medical capsule is a medical capsule disclosed in Japanese Patent Application Laid-Open No. 2009-61282.

### Example 2-2

A system according to Example 2-2 is a system having a second semiconductor that processes a first electric signal, which is output from the above mentioned system of Example 2-1, according to a program, and outputs a second electric signal.

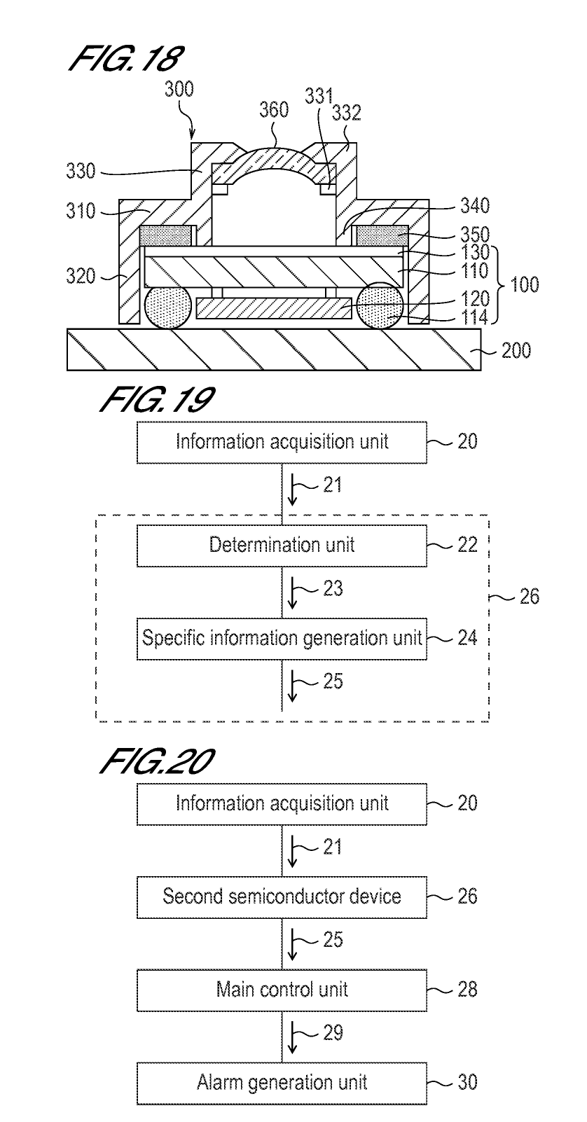

A suitable application example of this system is a vehicle monitoring module which is enclosed and used in a vehicle monitoring device disclosed in Japanese Patent Application Laid-Open No. 2010-170317. FIG. 19 is a block diagram depicting a general configuration of a vehicle monitoring module described as an example of the system of Example 2-2.

The configuration and operation of the vehicle monitoring module will be described with reference to FIG. 19. The vehicle monitoring module has an information acquisition unit 20, a determination unit 22, and a specific information generation unit 24. The above mentioned system of Example 2-1 enclosing the wide-angle lens of this embodiment, for example, is used for the information acquisition unit 20.

Monitoring items of the vehicle monitoring module are: burglary monitoring, vehicle vandalizing monitoring, doze prevention, improper operation monitoring, forward danger prevention (another vehicle, pedestrian), traffic sign recognition, headlight (top, bottom), white line recognition, forward danger recognition, forward vehicle start recognition, danger prevention in starting up, danger prevention in backing up, rear door monitoring for stopping and passing danger prevention.

If the information acquisition unit is constructed using the system of Example 2-1, video images of inside and outside the vehicle can be captured by the system of Example 2-1.

The system of Example 2-1 is configured so that the captured image data is transmitted to the determination unit 22 as a first electric signal 21. According to a program, the determination unit 22 analyzes the first electric signal 21 in which the information to be input is reflected, and determines, based on the difference from the predetermined reference state, whether or not it is necessary to inform vehicle occupants, such as a driver.

Pixels of the image data are analyzed to detect edges and to detect motion, and a significant image is extracted from the video images. A “significant image” is, for example, a white line on a road of which contrast is radically different from the peripheral area, and a pedestrian of which moving speed is clearly different from other images.

The determination result by the determination unit 22 is generated as a second electric signal 23, and is transmitted to the specific information generation unit 24. Based on the determination result by the determination unit 22, the specific information generation unit 24 generates text information 25 as the specific information. The generated specific information 25 is transmitted to a main control unit (not illustrated) via a communication line, for example.

As described above, the system of Example 2-2 is a system having the second semiconductor device 26 constituted by the determination unit 22 and the specific information generation unit 24, and processes the first electric signal 21 according to a program and outputs the second electric signal 23.

The above mentioned vehicle monitoring module or similar module is used as a driving support device disclosed in Japanese Patent Application Laid-Open No. 2010-228740, for example. In this driving support device, a stereo-camera is installed in a front area of the vehicle interior, and the stereo-camera captures images in front of the vehicle, so as to detect information on the external environment of the vehicle, including obstacles in front of the vehicle, the distance between the vehicle and obstacle, and roads and road boundaries, and inputs the detected result to a microcomputer. In this case, the stereo-camera plays a role of the system of Example 2-1, and the microcomputer plays a role of the system of Example 2-2.

The above mentioned vehicle monitoring module or similar module is used as a driver state monitoring device and collision control system disclosed in Japanese Patent Application Laid-Open No. 2010-18625. This driver state monitoring device comprises: camera control means for acquiring at least one of the state of the driver looking to the side or the state of the driver opening/closing their eyes; and driver support control means for calculating the estimated time until collision with an obstacle using the information detected by the obstacle detection means, and transmitting a signal to the camera control means to start operation only when the estimated time until collision is the threshold or less. In this case, the camera control means plays a role of the system of Example 2-1, and the driver support control means plays a role of the system of Example 2-2.

### Example 2-3

A system according to Example 2-3 is a system including a controlled device which performs predetermined mechanical control based on the second electric signal, which is output from the above mentioned system of Example 2-2.

A suitable application example of this system is, just like the system of Example 2-2, a system which is constituted by a main control unit and an alarm generation unit and is enclosed and used in the vehicle monitoring device disclosed in Japanese Patent Application Laid-Open No. 2010-170317. FIG. 20 is a block diagram depicting a general configuration of a system which is constituted by the main control unit and the alarm generation unit, and is enclosed and used in the vehicle monitoring device described as an example of the system of Example 2-2.

The configuration and operation of the system, which is constituted by the main control unit and the alarm generation unit and is enclosed and used in the vehicle monitoring device, will be described with reference to FIG. 20.

The alarm generation unit 30 is connected to the main control unit 28. The main control unit 28 receives specific information 25 from a vehicle monitoring module, and controls operation of the alarm generation unit 30. In some cases, a plurality of monitoring modules may be installed so that the main control unit 28 receives specific information, which is output from each of the plurality of vehicle monitoring modules respectively.

The main control unit 28 receives specific information 25, which is the second electric signal, from the vehicle monitoring module, and performs predetermined control for the alarm generation unit 30. The controlled device is the alarm generation unit 30 in this case, and emits sound or light as an alarm, or may be a device having a function to execute mechanical control, such as applying vibration to a driver.

The on-vehicle camera system disclosed in Japanese Patent Application Laid-Open No. 2006-182234, a crime prevention image management device disclosed in Japanese Patent Application Laid-Open No. 2007-081636, or the playroom machine monitoring device disclosed in Japanese Patent Application Laid-Open No. 2006-149409 is constructed with the basic components of the system of Example 2-3. Therefore the wide-angle lens of the present invention can be suitably used for the imaging lens of a camera enclosed by these systems or devices.

In this application, the contents disclosed in Japanese Patent Application Laid-Open No. 2006-149409, Japanese Patent Application Laid-Open No. 2006-182234, Japanese Patent Application Laid-Open No. 2007-081636, Japanese Translation of PCT Application No. 2008-532574 (US 2008255416), Japanese Patent Application Laid-Open No. 2009-178568 (U.S. Pat. No. 7,144,401), Japanese Patent Application Laid-Open No. 2009-061282, Japanese Patent Application Laid-Open No. 2010-170317, Japanese Patent Application Laid-Open No. 2010-186251, Japanese Patent Application Laid-Open No. 2010-188153 (US 7344545), and Japanese Patent Application Laid-Open No. 2010-228740 are integrated in the description of the present application. If a corresponding US patent publication exists or is disclosed later, these disclosed contents are also integrated herein.

### EXPLANATION OF REFERENCE NUMERALS

CG cover glass
S aperture stop
L1 first lens
L2 second lens
L3 third lens
L4 fourth lens
rᵢ axial radius of curvature of i-th surface
dᵢ distance from i-th surface to (i+1)-th surface
10 solid-state image sensor
20 information acquisition unit
22 determination unit
24 specific information generation unit
26 second semiconductor device
28 main control unit
30 alarm generation unit
100 image sensor package
110 glass substrate
114 connection terminal
120 image sensor chip
130 R cut-off filter
200 printed circuit board (first semiconductor device)
300 lens housing
310 horizontal portion
320 extended portion
330 lens mounting portion
331 lens holding portion
332 lens securing portion
340 protruded portion
350 adhesive
360 wide-angle lens

1. A wide angle lens, comprising:
a first lens L1, a second lens L2, a third lens L3, an aperture stop S and a fourth lens L4, which are disposed from an object toward an image, in order of said first lens L1, said second lens L2, said third lens L3, said aperture stop S and said fourth lens L4, wherein
said first lens L1 is a meniscus lens having negative refractive power, of which convex surface faces the object,
said second lens L2 is a meniscus lens having positive refractive power, of which convex surface faces the image,
said third lens L3 and said fourth lens L4 are lenses having positive refractive power, and
at least both surfaces of said second lens L2 and those of said third lens L3 are aspherical, wherein
the following condition is satisfied:
0.15≦f/D≦0.20 (1)
23((d2(40 (2)
85((d3(50 (3)
where f denotes a combined focal length provided by four lenses, which are said first lens L1, said second lens L2, said third lens L3 and said fourth lens L4, D denotes a distance from the entrance plane on the object side to the image formation plane, (d 2 denotes an Abbe number of the material of said second lens, and (d3 denotes an Abbe number of the material of the third lens.

2-3. (canceled)

4. The wide-angle lens according to claim 1, wherein
said first lens L1 is a lens formed of optical glass or optical resin as a material,
said second lens L2 and said third lens L3 are lenses formed of optical resin as a material, and
said fourth lens L4 is a lens formed of optical glass or optical resin as a material.

5. The wide-angle lens according to claim 4, wherein
said first lens L1 is a lens formed of optical resin as a material,
said second lens L2 is a lens formed of optical resin as a material,
said third lens L3 is a lens formed of optical resin of a material, and
said fourth lens L4 is a lens formed of optical glass as a material.

6. The wide-angle lens according to claim 4, wherein
said first lens L1 is a lens formed of optical glass as a material,
said second lens L2 is a lens formed of optical resin as a material,
said third lens L3 is a lens formed of optical resin as a material, and
said fourth lens L4 is a lens formed of optical glass as a material.

7. The wide-angle lens according to claim 4, wherein
said first lens L1 is a lens formed of optical resin as a material,
said second lens L2 is a lens formed of optical resin as a material,
said third lens L3 is a lens formed of optical resin as a material, and
said fourth lens L4 is a lens formed of optical resin as a material.

8. The wide-angel lens according to claim 4, wherein
said first lens L1 is a lens formed of cycloolefin plastic as a material,
said second lens L2 is a lens formed of polycarbonate plastic as a material,
said third lens L3 is a lens formed of cycloolefin plastic as a material, and
said fourth lens L4 is a lens formed of crown glass as a material.

9. The wide-angle lens according to claim 4, wherein
said first lens L1 is a lens formed of crown glass as a material,
said second lens L2 is a lens formed of polycarbonate plastic as a material,
said third lens L3 is a lens formed of cycloolefin plastic as a material, and
said fourth lens L4 is a lens formed of crown glass as a material.

10. The wide-angle lens according to claim 4, wherein
said first lens L1 is a lens formed of cycloolefin plastic as a material,
said second lens L2 is a lens formed of polycarbonate plastic as a material,
said third lens L3 is a lens formed of cycloolefin plastic as a material, and
said fourth lens L4 is a lens formed of cycloolefin plastic as a material.

11. (canceled)

12. A system comprising:
a wide-angle lens; and
a first semiconductor device which converts optical image information received via the wide-angle lens into a first electric signal via a semiconductor chip disposed on the image side of the wide-angle lens, wherein
said wide-angle-lens includes a first lens L1, a second lens L2, a third lens L3, an aperture stop S and a fourth lens L4, which are disposed from an object toward the image, in order of said first lens L1, said second lens L2, said third lens L3, said aperture stop S and said fourth lens L4,
said first lens L1 is a meniscus lens having negative refractive power, of which convex surface faces the object,
said second lens L2 is a meniscus lens having positive refractive power, of which convex surface faces the image,
said third lens L3 and said fourth lens L4 are lenses having positive refractive power, and
at least both surfaces of said second lens L2 and those of said third lens L3 are aspherical, wherein
the following condition is satisfied:
0.15≦f/D≦0.20 (1)
23≦ν_{d2}≦40 (2)
85≧ν_{d3}≧50 (3)
where f denotes a combined focal length provided by four lenses, which are said first lens L1, said second lens L2, said third lens L3 and said fourth lens L4, D denotes a distance from the entrance plane on the object side to the image formation plane, (d2 denotes an Abbe number of the material of said second lens, and (d3 denotes an Abbe number of the material of the third lens.

13. The system according to claim 12, further comprising:
a second semiconductor device to which the first electric signal that is output by the first semiconductor device is supplied, and which processes the first electric signal according to a program, and generates and outputs a second electric signal.

14. The system according to claim 13, further comprising:
a controlled device to which the second electric signal that is output by the second semiconductor device is supplied, and which performs predetermined control based on the second electric signal.

15. (canceled)
